(19) United States
(12) Patent Application Publication
(10) Pub. No.: US 2014/0159323 A1
(43) Pub. Date: Jun. 12, 2014

(54) CHUCK FOR A BALL-NOSE MILLING CUTTER

(71) Applicant: GÜHRING OHG, Albstadt (DE)

(72) Inventor: Lutfi BOZKURT, Winterlingen (DE)

(73) Assignee: GÜHRING OHG, Albstadt (DE)

(21) Appl. No.: 14/180,555

(22) Filed: Feb. 14, 2014

Related U.S. Application Data
(63) Continuation of application No. PCT/EP2012/066002, filed on Aug. 16, 2012.

(30) Foreign Application Priority Data
Aug. 16, 2011 (DE) 102011052753.2

(51) Int. Cl. B23C 5/26; B23B 31/11

(52) U.S. Cl. CPC B23C 5/26; B23B 31/11
USPC 279/99

(57) ABSTRACT

The description comprises a chuck for clamping a ball-nose milling cutter, comprising: a worm gear unit with a worm gear 111 and a screw 113, wherein the chuck comprises a sleeve 103 with a first inside thread 118, wherein the sleeve 103 is axially movable by a rotational motion of the worm gear 111, wherein a first outside thread 105 of the ball-nose mill cutter is arranged so as to engage with the first inside thread 118.

### FIELD OF THE INVENTION

The present invention relates to a chuck for clamping a ball-nose milling cutter.

### BACKGROUND OF THE INVENTION

Known in prior art are jaw chucks or clamping chucks, with which tools, such as ball-nose milling cutters, can be clamped into a machine tool.

### SUMMARY OF THE INVENTION

While machining workpieces, tools, in particular ball-nose milling cutters, are exposed to high mechanical loads, for example also including transverse loads. Therefore, it should be ensured that the tool is clamped into a respective machine tool in as mechanically stable a manner as possible. In addition, ever shorter tool changeover times are being required to achieve a high production output. Therefore, the affected operating personnel may be faced with conflicting objectives, i.e., between attaching the tool to a machine tool in a stable manner, which requires a lot of time, and effecting a quick tool changeover.

Therefore, the object is to provide a chuck that enables a mechanically very stable clamping, while still allowing short tool changeover times.

Provided as the first embodiment of the invention is a chuck for clamping a ball-nose milling cutter, comprising: a worm gear unit with a worm gear and screw, wherein the clamp encompasses a sleeve with a first female thread, wherein the sleeve can be axially moved by a rotational motion of the worm gear, wherein a first male thread of the ball-nose milling cutter is arranged so as to engage with the first female thread.

The invention provides a sleeve inside a chuck, into which a ball-nose milling cutter can be screwed, wherein the sleeve can be designed so as to be axially traversed by a worm gear unit. This advantageously ensures that the thread retaining the ball-nose milling cutter and the thread engaging into the worm gear and allowing an axial movement for clamping purposes are two different, separate threads. Therefore, if the operating personnel screw the ball-nose milling cutter deep enough into the sleeve, an overall mechanically stable connection between the ball-nose milling cutter and machine tool can be ensured, since the tool itself can guarantee that only one or just a few turns of a thread will never suffice to secure the sleeve inside the worm gear unit, despite the axial traversal for clamping the ball-nose milling cutter.

Exemplary embodiments are described in the dependent claims.

An exemplary embodiment of the invention provides a chuck, wherein the sleeve exhibits a second male thread, wherein the second male thread is arranged so that it can engage into a second female thread of the worm gear.

The link between the sleeve and worm gear unit can be established with a male thread/female thread connection, making it easy from a structural standpoint to achieve an axial shifting of the sleeve via a rotational motion of the worm gear.

Another embodiment according to the invention provides a chuck, wherein the second male thread is arranged opposite the first female thread.

Arranging the first female thread opposite the second male thread makes it possible to lengthen the chuck with a slender front region, so that the ball-nose milling cutter can also mill ball paths lying even further down.

Another exemplary embodiment of the present invention provides a chuck, wherein the chuck exhibits a stop for the ball-nose milling cutter.

A stop can ensure that the respective ball-nose milling cutter is screwed deeply enough into a sleeve according to the invention, making it possible to achieve a mechanically stable clamping of the ball-nose milling cutter.

An exemplary embodiment of the invention provides a chuck, wherein the chuck exhibits a stop for the sleeve.

A stop for the sleeve can prevent the sleeve from penetrating too deeply info the chuck, making it possible to prevent jamming.

Another embodiment according to the invention provides a chuck, wherein the screw exhibits an inner profile, for example a hexagon socket, and/or wherein the inner profile can be accessed from outside.

Arranging an inner profile, for example a hexagon socket, makes it easy, e.g., using a socket wrench or hook wrench, to advance the worm gear unit, making it possible to clamp and unclamp a tool, e.g., a ball-nose milling cutter.

Another exemplary embodiment of the present invention provides a chuck, wherein the chuck exhibits a hollow shank taper interface or steep taper interface.

Arranging a hollow shank taper or steep taper interface makes it possible to insert the chuck into a corresponding machine tool in a mechanically stable manner.

Another embodiment according to the invention provides a chuck, wherein the chuck has an internal cone for accommodating a conical segment of the ball-nose milling cutter.

A conical region of the chuck for accommodating a conical segment of the ball-nose milling cutter makes it possible to center the ball-nose milling cutter in the respective chuck.

One idea of the invention involves providing a chuck with s sleeve, wherein the sleeve is designed to be axially displaced by a worm gear unit, and can be detachably mechanically connected, e.g., bolted, with a ball-nose milling cutter. A thread of the sleeve can be used to axially move the sleeve. All told, then, a first thread can be provided for connection with the ball-nose milling cutter, and another thread for axial traversal.

Of course, the individual features can also be combined with each other, which partially can result in advantageous effects that go beyond the sum of individual effects.

### BRIEF DESCRIPTION OF THE DRAWINGS

Additional details and advantages of the invention may be gleaned from the exemplary embodiment depicted in the drawing. Shown on:

FIG. 1 is a chuck for a ball-nose milling cutter.

### DETAILED DESCRIPTION OF EXEMPLARY EMBODIMENTS

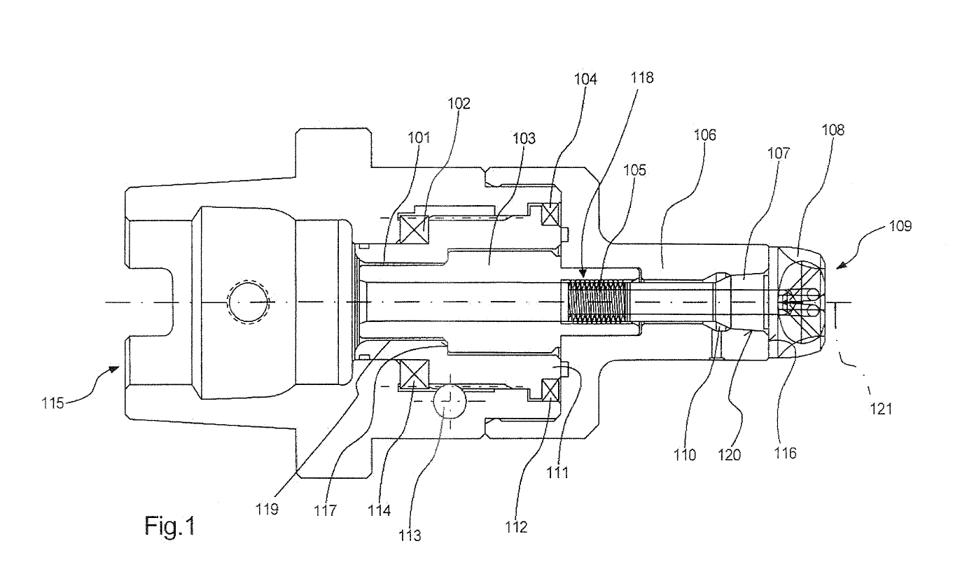

FIG. 1 shows a chuck for a ball-nose milling cutter, wherein the ball-nose milling cutter exhibits several sections, for example specifically a section with a male thread 105, which can engage into a female thread 118 of a sleeve 103. Another section 107 with a conical design can be clamped into an internal cone 120 of a receptacle 106, and a tool head 109 exhibiting blades 108 for processing the workpiece. The chuck exhibits a worm gear unit for clamping and unclamping a ball-nose milling cutter with a worm gear 111, which can be driven by a worm gear 113. For example, the worm gear 113 can encompass a hexagon socket, into which a hook wrench can engage. In this way, the worm gear 111 can be rotated around its longitudinal axis from outside, so that the sleeve 103 can traverse a female thread/male thread connection in an axial manner, i.e., along its longitudinal axis 121. The axial movement of the sleeve 103 makes it possible to clamp a ball-nose milling cutter placed in the chuck if the sleeve 103 is moved in the direction of the hollow shank taper interface 115. If the sleeve 103 is moved away from the hollow shank taper interface 115, the ball-nose milling cutter can be unscrewed, i.e., the male thread 105 is unscrewed from the sleeve 103, and the tool can be changed out. A clamping process involves placing the ball-nose milling cutter into the chuck, wherein the ball-nose milling cutter is screwed into the sleeve 103. By rotating the screw 113 around its longitudinal axis, for example using an inserted hook wrench, the worm gear 111 is made to rotate around its longitudinal axis, and the sleeve 103 can be moved to the hollow shank taper interface 115, for example, causing the ball-nose milling cutter to also move to the hollow shank taper interface 115, and make it abut against the receptacle 106 at position 116, thereby clamping in the ball-nose milling cutter. The clamping principle according to the invention can advantageously be used to prevent the sleeve 103 and worm gear 111 from being engaged only by a few or only individual turns of a thread due to an operator error. As a result, the sleeve 103 can be reliably prevented from breaking out of the worm gear 111.

Let it be noted that the term “encompass” does not preclude other elements or procedural steps, just as the term “a” or “an” does not rule out several elements.

The used reference numbers serve only to improve comprehensibility, and by no means are to be construed as limiting, wherein the protective scope of the invention is described by the claims.

### LIST OF REFERENCE NUMBERS

101 Male thread of sleeve

102 Bearing

103 Sleeve

104 Bearing

105 Male thread of ball-nose milling cutter

106 Chuck receptacle

107 Conical section of ball-nose milling cutter

108 Ball-nose milling cutter blade

109 Ball-nose milling cutter head

110 Free space of receptacle

111 Worm gear

112 Bearing

113 Screw

114 Bearing

115 Hollow shank taper interface

116 Stop

117 Stop

118 Female thread of sleeve

119 Female thread of worm gear

120 Internal cone of chuck

121 Longitudinal axis

1. A chuck for clamping a ball-nose milling cutter, encompassing a worm gear unit with a worm gear and a screw,
wherein
the chuck encompasses a sleeve with a first female thread, wherein the sleeve can be axially moved by a rotational motion of the worm gear, wherein a first male thread of the ball-nose milling cutter is arranged so as to engage with the first female thread.

2. The chuck according to claim 1, wherein the sleeve exhibits a second male thread, wherein the second male thread is arranged so that it can engage into a second female thread of the worm gear.

3. The chuck according to claim 1, wherein the second male thread is arranged opposite the first female thread.

4. The chuck according to claim 1, wherein the chuck exhibits a stop for the ball-nose milling cutter.

5. The chuck according to claim 1, wherein the chuck exhibits a stop for the sleeve.

6. The chuck according to claim 1, wherein the screw exhibits an inner profile, for example a hexagon socket, and/or wherein the inner profile can be accessed from outside.

7. The chuck according to claim 1, wherein the chuck exhibits a hollow shank taper interface or steep conical interface.

8. The chuck according to claim 1, wherein the chuck exhibits an internal cone for accommodating a conical section of the ball-nose milling cutter.
